(19) United States
(12) Patent Application Publication
(10) Pub. No.: US 2005/0175912 A1
(43) Pub. Date: Aug. 11, 2005

(54) Electrophotographic photosensitive devices and manufacturing methods thereof

(76) Inventors: Ikuo Takaki, Nagano (JP); Yoichi Nakamura, Nagano (JP); Yuki Matsuura, Nagano (JP)

Correspondence Address: RABIN & Berdo, PC, 1101 14TH STREET, NW, SUITE 500, WASHINGTON, DC, 20005, US

(21) Appl. No.: 11/030,314

(22) Filed: Jan. 7, 2005

(30) Foreign Application Priority Data
Jan. 19, 2004 (JP) JP PA 2004-010462

(51) Int. Cl. G03G 5/047

(52) U.S. Cl. 430/59.5; 430/96; 430/59.1; 430/59.4

(57) ABSTRACT

An improved electrophotographic photosensitive device is disclosed. The device comprises a photosensitive layer coupled to a conductive substrate. The photosensitive layer preferably includes a vinyl chloride resin and the vinyl chloride resin preferably comprises an acid esterified vinyl chloride polymer having polymer hydroxy groups, epoxy groups and strong acid radicals as substituent groups, so that the epoxy groups and the hydroxy groups are partially esterified.

### RELATED APPLICATION

This application claims priority benefits under 35 USC § 119 of Japanese Patent Application Serial No. 2004-010462, filed Jan. 19, 2004, the disclosure of which is incorporated by reference.

### FIELD OF THE INVENTION

The present invention relates to electrophotographic photosensitive devices used in electrophotographic printers, copying machines, facsimile machines and the like, and manufacturing methods thereof, and more particularly relates to an electrophotographic photosensitive device having stable environmental (room temperature, humidity) use characteristics, and manufacturing methods thereof.

### BACKGROUND OF THE INVENTION

In the past, inorganic photosensitive devices having photosensitive layers comprising inorganic photo-conductive substances such as selenium or selenium alloys, zinc oxide, cadmium sulfide or the like have been widely used as photosensitive substances used in electrophotographic photosensitive devices (also referred to as “photosensitive devices” below). However, more recently there has been active research and development directed to electrophotographic photosensitive devices using various types of organic photo-conductive materials as photosensitive layer materials, since such electrophotographic photosensitive devices have a low manufacturing cost, and can also reduce pollution and environmental contamination.

Prior art function-separating type photosensitive devices comprise a photosensitive layer having a charge generating layer comprising a charge generating substance laminated with a charge transporting layer including a charge transporting substance. Such function-separating type photosensitive devices have constituted the mainstream development pathway for improving performance characteristics such as sensitivity and durability. For example, numerous organic laminated type photosensitive devices have been proposed. These organic laminated type photosensitive devices have a charge generating layer comprising an organic pigment dispersed in a resin binder as a charge generating substance, or a charge generating layer comprising a vacuum-evaporated layer of an organic pigment, and have a charge transporting layer comprising a low-molecular organic compound dispersed or dissolved in a resin binder as a charge transporting substance, with each of the above-described layers being laminated in that order.

Furthermore, in recent years, especially in view of the increase in the number of sheets printed due to the creation of office networks, as well as the rapid development of light printers using electrophotography and the like, there has been a demand for increasingly high sensitivity and high-speed response in electrophotographic printers, and at the same time a strong demand for reduced fluctuation in image characteristics and the like caused by changes in room temperature and humidity during use.

Currently the abovementioned required characteristics are not always completely achieved in the case of the abovementioned photosensitive devices, and the following problems still exist.

First, image characteristics deterioration in low-temperature, low-humidity environments occurs. Specifically, in a low-temperature, low-humidity environment, there is generally an apparent drop in the image density caused by a drop in the image sensitivity characteristics and the like of the photosensitive device, and a latent deterioration in image quality results, i. e., a deterioration of the gradations in halftone images. Furthermore, the image memory that accompanies sensitivity characteristics deterioration may also be conspicuous. This is an image deterioration in which images that are recorded as latent images during the first rotation of the drum in printing are also recorded (especially when halftone images are printed), so that these images are affected by fluctuations in potential from a second rotation of the drum and so on. In particular, there are numerous instances in which negative memory (in which the optical density of the printed images is inverted) is conspicuously seen at low temperatures and low humidity levels.

Second, image characteristics deterioration in high-temperature high-humidity environments occurs. Specifically, in a high-temperature high-humidity environment, the velocity at which the charge moves through the photosensitive layer is generally increased compared to that seen at ordinary temperature and humidity. As a result of this phenomenon, problems such as an excessive increase in printing density, small black spots in a solid white image (fogging) and the like are seen. An excessive increase in printing density leads to an increase in toner consumption and furthermore, the diameter of individual dots is increased so that fine gradations are destroyed. Moreover, with regard to image memory as well, it is common to have cases in which a positive memory (in which the optical density of the printed images is reflected “as is”) is conspicuously seen, contrary to the conditions seen in a low-temperature low-humidity environment.

Such characteristics deterioration is commonly caused by the absorption and release of moisture by the charge generating material and a resin binder comprising a portion of the charge-generating layer. Various types of materials have been investigated in the past; however, materials that can sufficiently satisfy the requirements for various characteristics in these photosensitive devices have not yet been discovered.

### SUMMARY OF THE INVENTION

Accordingly, in light of the abovementioned problems, an object of the present invention is to provide an electrophotographic photosensitive device that is less affected by temperature or humidity environmental fluctuations and showing improved electrical stability characteristics with reduced occurrence of image problems in memory characteristics and the like.

A further object of the invention is to provide a manufacturing method for an electrophotographic photosensitive device less affected by temperature or humidity environmental fluctuations and showing improved electrical stability characteristics with reduced occurrence of image problems in memory characteristics and the like.

In order to solve the abovementioned problems, the electrophotographic photosensitive device of the present invention is an electrophotographic photosensitive device comprising a photosensitive layer on a conductive substrate, wherein a vinyl chloride resin is used with a structure including a vinyl chloride resin, the vinyl chloride resin comprising an acid esterified vinyl chloride polymer having polymer hydroxy groups, epoxy groups and strong acid radicals as substituent groups, so that a portion of the epoxy groups and a portion of the hydroxy groups are esterified.

Furthermore, the present invention provides a method for manufacturing an electrophotographic photosensitive device comprising the step of coating the surface of a conductive substrate with a coating liquid thereby providing a photosensitive layer including an electrophotographic photosensitive material, the coating liquid comprising a vinyl chloride resin, the vinyl chloride resin being an acid esterified vinyl chloride polymer having polymer hydroxy groups, epoxy groups and strong acid radicals as substituent groups, so that a portion of the epoxy groups and a portion of the hydroxy groups are esterified.

The foregoing and other objects, features, and advantages of the invention will be apparent from the following, more detailed description of the preferred embodiments of the invention, as illustrated in the accompanying drawings.

### BRIEF DESCRIPTION OF THE PREFERRED EMBODIMENTS

The present inventors determined a relationship between substituent groups of a binder resin and environmental characteristics suitable for use as a charge-generating layer in a photosensitive device. Such a photosensitive device has diminished environmental dependence and comprises the esterified vinyl chloride resin of the present invention as a resin binder.

The charge-generating layer is generally manufactured from a coating liquid comprising a resin binder dissolved in an organic solvent, and having a charge generating material therein. Depending on the structure of the resin binder, the dispersion of the charge generating material may lead to unnecessarily high second-order or higher-order aggregation, thus leading to precipitation. In order to suppress such aggregation and precipitation, a resin binder with substituent groups that appropriately stabilize the charge generating material in a liquid should be selected.

Furthermore, preferably the environmental dependence of the photosensitive device is diminished by inhibiting the moisture effects on the charge generating material, especially when the photosensitive device may be affected by the environment. Preferably, environmental humidity effects are taken into account by considering the substituent group effects of the resin binder that may form hydrogen bonds with water molecules, such as those of hydroxy groups and the like. A preferred resin binder comprises a suitable structure binding water molecules to an appropriate degree at low humidity that tends to be unaffected by excess water molecules at high humidity.

With reference to vinyl chloride resin binders that have epoxy groups, Japanese Patent Application Laid-Open No. 61-89207 discloses a binder suitable for a magnetic recording medium. Additionally, the embodiments of Japanese Patent Application Laid-Open No. 1-307759, the embodiments of Japanese Patent Application Laid-Open No. 4-159559, the embodiments of Japanese Patent Application Laid-Open No. 5-113684 and the embodiments of Japanese Patent Application Laid-Open No. 6-167818, and the like disclose examples of vinyl chloride resin binders used in electrophotographic photosensitive devices. The MR series (MR 110, MR 112, MR 555) manufactured by Zeon Corporation and the like are further examples of suitable binders.

Compared to butyral resin binders and the like, vinyl chloride resin binders having hydroxy groups and epoxy groups that bind hydrogen bonds to water provide useful advantages such as a high sensitivity, a low residual potential and the like. However, such binders do not sufficiently diminish humidity effects. In the present invention, an acid, especially an acid anhydride, such as acetic anhydride and the like, suitably reacts with a portion of the hydroxy groups and a portion of the epoxy groups of the vinyl chloride resin of the present invention, thereby providing an esterified structure. Therefore, it is possible to manufacture a photosensitive device binding water molecules to an appropriate degree, and having relatively high stability in various environments (ranging from low temperature and low humidity to high temperature and high humidity), while permitting dispersion of the charge generating material therein.

An electrophotographic photosensitive device comprising a suitable vinyl chloride resin according to the present invention has stable initial electrical characteristics. During repeated use in the presence of environmental fluctuations, the device has reduced image deterioration in the image memory and the like.

This occurs regardless of various types of charging processes or developing processes that may be used, or various types of processes such as negative charging processes or positive charging processes of the photosensitive device that may be used.

### BRIEF DESCRIPTION OF THE DRAWINGS

FIG. 1(a) depicts a schematic sectional view of a negatively charged function-separating laminated electrophotographic photosensitive device according to the present invention.

FIG. 1(b) depicts a schematic sectional view of a positively charged function-separating laminated electrophotographic photosensitive device according to the present invention.

FIG. 2 is an infrared spectrum chart of a vinyl chloride resin binder.

FIG. 3 is an infrared spectrum chart of compound A according to the present invention.

### DETAILED DESCRIPTION OF THE PREFERRED EMBODIMENTS

Generally, electrophotographic photosensitive devices may be categorized as function-separating type photosensitive devices (so-called negatively charged laminated photosensitive devices) and positively charged laminated photosensitive devices.

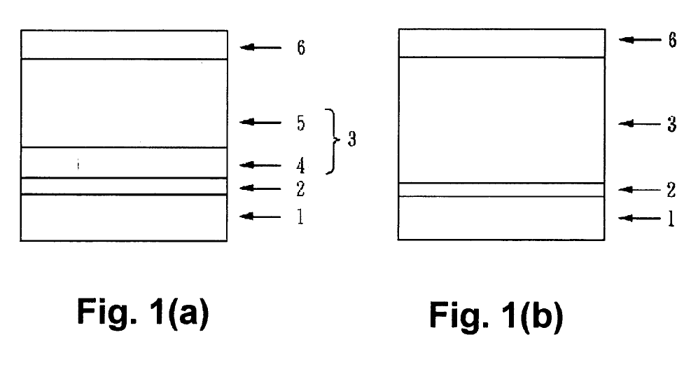

FIGS. 1(a) and 1(b) are each schematic sectional views depicting an electrophotographic photosensitive device consistent with an embodiment of the present invention. FIG. 1 (a) depicts a negatively charged laminated electrophotographic photosensitive device consistent with an embodiment of the present invention, while FIG. 1 (b) depicts a positively charged single layer electrophotographic photosensitive device consistent with another embodiment of the present invention. As depicted in FIG. 1(a), the negatively charged photosensitive device comprises a laminate having a conductive substrate 1 an intermediate layer 2, a photosensitive layer 3 comprising a charge-generating layer 4 functioning as a charge generator, and a charge-transporting layer 5 functioning as a charge transporter. In contrast, in the embodiment of FIG. 1(b), the positively charged single layer photosensitive device comprises a laminate having a conductive substrate 1, an intermediate layer 2 and a single photosensitive layer 3 which functions both as a charge generator and as a charge transporter. Furthermore, in both types of photosensitive devices, the laminate structure may further comprise a surface protective layer 6 over the photosensitive layer 3.

The conductive substrate 1 provides a support for the respective layers of the photosensitive device while at the same time functioning as one electrode of the photosensitive device, and may have a cylindrical, plate-form or film-form shape. The conductive substrate 1 preferably comprises a metal such as aluminum, stainless steel, nickel and the like, or a surface treated material such as a glass, a resin and the like having a conductive treatment.

The intermediate layer 2 preferably comprises a layer having a resin, or a metal oxide coated film such as alumite and the like. This intermediate layer 2 controls injection of charge into the photosensitive layer from the conductive substrate 1 or covers defects in the surface of the substrate thereby improving the adhesion between the photosensitive layer and an undercoat layer (not shown) and the like. Examples of resins suitable as an undercoat layer include insulating macromolecules such as casein, polyvinyl alcohols, polyamides, melamine, cellulose and the like, or conductive macromolecules such as polythiophenes, polypyrroles, polyanilines and the like. These underlayer resins can be used singly or as mixtures in appropriate combinations. Furthermore, these underlayer resins may also comprise metal oxides such as titanium dioxide, zinc oxide and the like.

A coating liquid prepared by dispersing particles of a charge generating material in a binder resin as described above permits a coating process resulting in the charge generating layer 4 of the negatively charged photosensitive device of FIG. 1(a). This layer 4 receives light and generates a charge. Furthermore, preferably the charge generation efficiency is high, and concurrently the injection of the generated charge into the charge transporting layer 5 is important, and preferably the electric field dependence is small so that the injection is adequate even in a low electric field. Phthalocyanine compounds such as X type non-metallic phthalocyanines, τ type non-metallic phthalocyanines, α type titanylphthalocyanine, β type titanylphthalocyanine, Y type titanylphthalocyanine, γ type titanylphthalocyanine, amorphous titanylphthalocyanine, ε type copper phthalocyanine and the like, and various types of azo pigments, anthanthrone pigments, tiapyryllium pigments, perylene pigments, perynone pigments, squarylium pigments and quinacridone pigments and the like may be used singly or in appropriate combinations as charge generating materials. A suitable choice for charge-generating materials depends on the light wavelength region of the exposing light source used for image formation. Preferable compounds suitable as charge generating materials are titanylphthalocyanines characterized by having a maximum amplitude at 27.2° in the Bragg angle 2θ X-ray crystal diffraction of the titanylphthalocyanine.

It is sufficient if the charge generating layer 4 functions as a charge generator. The film thickness of this layer 4 depends on the light absorption coefficient and is generally 1 μm or less, and is preferably 0.5 μm or less. It would also be possible to use a charge generating material as the main portion of the charge-generating layer 4, and to add a charge transporting material and the like to this layer 4. Preferably, the esterified vinyl chloride resin provided by the present invention can be used alone as the resin binder. Alternatively, this esterified vinyl chloride resin can be combined with a polymer or copolymer such as a polycarbonate resin, polyester resin, polyamide resin, polyurethane resin, vinyl chloride resin, vinyl acetate resin, phenoxy resin, polyvinylacetal resin, polyvinylbutyral resin, polystyrene resin, polysulfone resin, diallyl phthalate resin, methacrylic acid ester resin and the like. However, an appropriate mixture ratio proportion must be determined such that epoxy equivalents are as described below (according to the epoxy equivalents of the esterified vinyl chloride as provided by the present invention). Preferably, the epoxy equivalents of the vinyl chloride resin of the present invention which is an acid esterified vinyl chloride polymer having polymer hydroxy groups, epoxy groups and strong acid radicals as substituent groups so that the abovementioned epoxy groups and hydroxy groups are partially converted into ester groups is at least 2,000 g/equiv. and not greater than 20,000 g/equiv., and the mean degree of polymerization of the acid esterified vinyl chloride polymer is preferably 200 to 600.

The charge-transporting layer 5 preferably comprises a charge transporting material and a resin binder. Suitable charge transporting materials include various types of hydrazone compounds, styryl compounds, diamine compounds, butadiene compounds, indole compounds and the like used singly or mixed in appropriate combinations, and suitable resin binders include polycarbonate resins such as bisphenol A type, bisphenol Z type resins, bisphenol A type—biphenyl copolymers and the like, polystyrene resins, polyphenylene resins and the like, used singly or mixed in appropriate combinations. Preferably, 2 to 50 parts by weight of such compounds are used, and more preferably 3 to 30 parts by weight are used of charge transporting material per 100 parts by weight of resin binder. The film thickness of the charge-transporting layer 5 is preferably in the range of 3 to 50 μm, and is more preferably in the range of 15 to 40 μm to maintain a practically effective surface potential.

Some charge transporting materials I-1 to I-13 that can be used in the present invention are shown below, it being understood that the present invention is not limited to these specific charge-transporting materials I-1 to I-13.

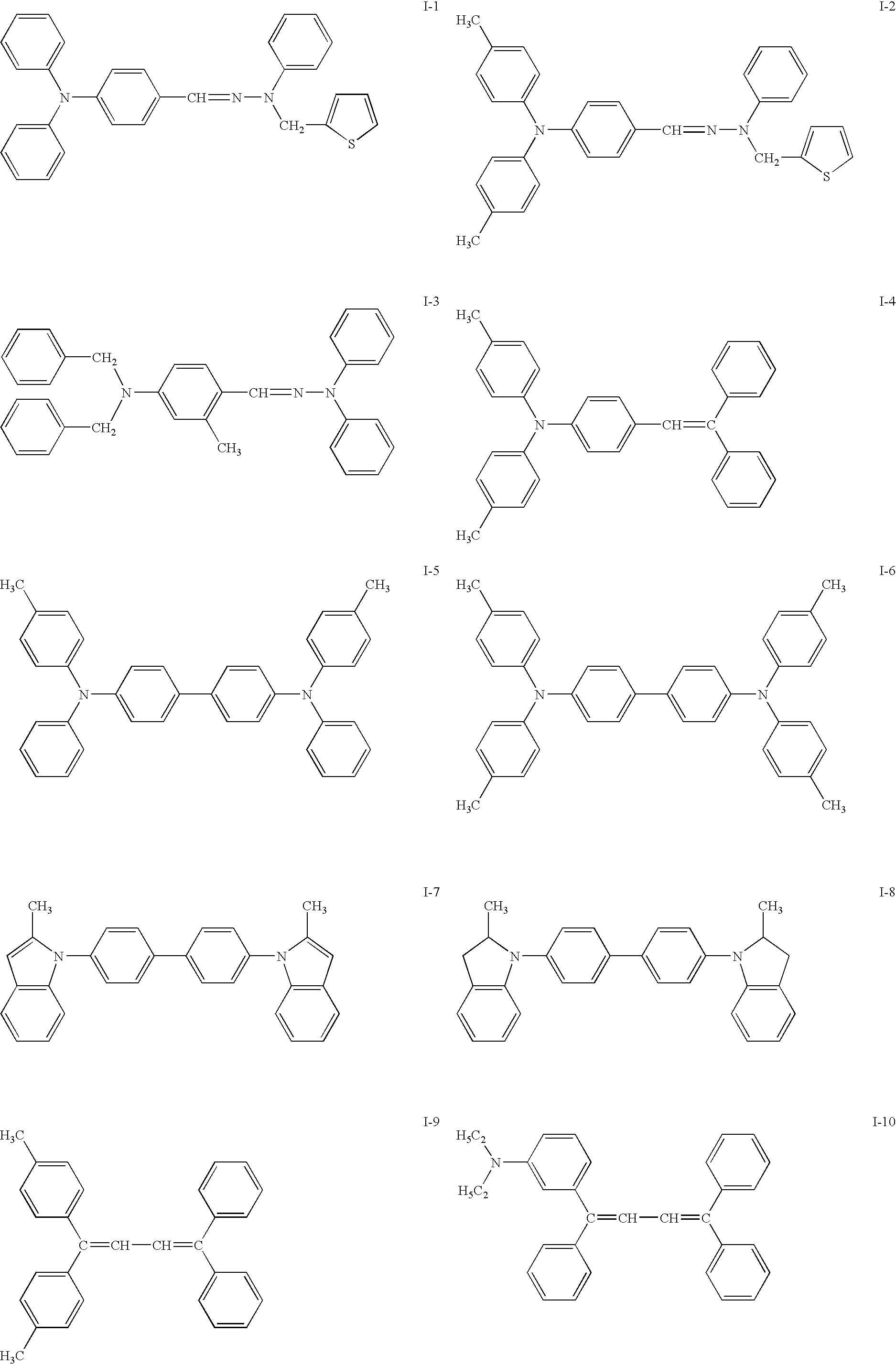

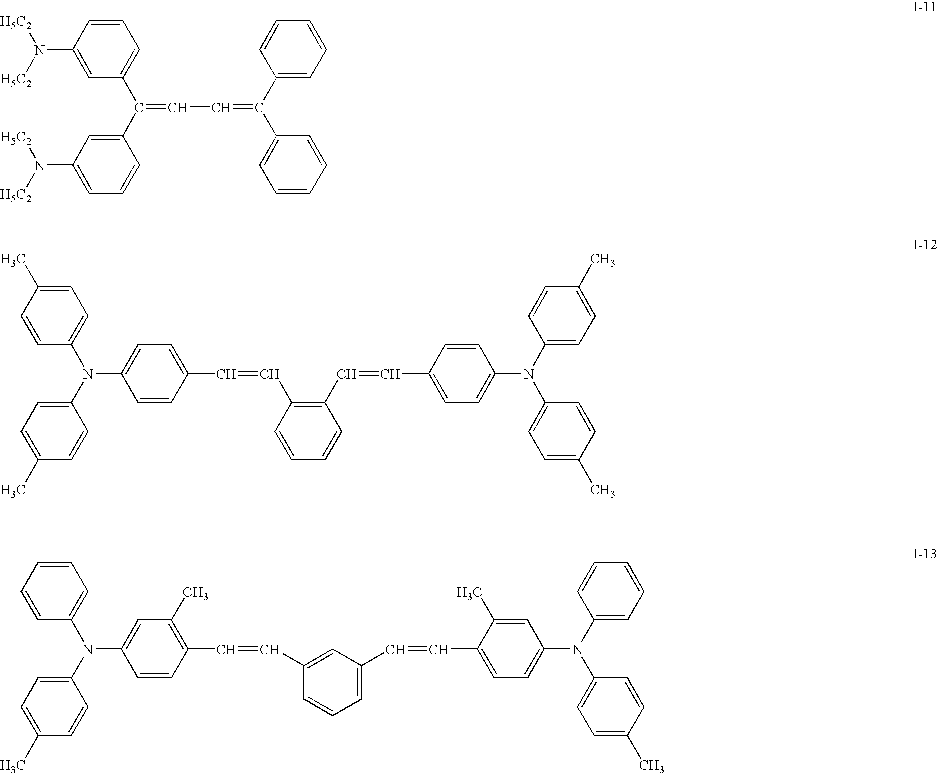

Furthermore, environmental resistance and stability with respect to degradation by light and the like may be improved with various types of additives in the intermediate layer 2, charge generating layer 4 and charge transporting layer 5, thereby improving sensitivity and reducing the residual potential. Examples of additives that can be used include compounds such as succinic anhydride, maleic anhydride, succinic dibromic anhydride, pyromellitic anhydride, pyromellitic acid, trimellitic acid, trimellitic anhydride, phthalimide, 4-nitrophthalimide, tetracyanoethylene, tetracyanoquinodimethane, chloranyl, bromanyl, o-nitrobenzoic acid, trinitrofluorenone and the like. Furthermore, oxidation inhibitors, photo-stabilizers and the like may also be added, examples of such compounds including chromanol derivatives such as tocopherol and the like, ether compounds, ester compounds, polyarylalkane compounds, hydroquinone derivatives, diether compounds, benzophenone derivatives, benzotriazole derivatives, thioether compounds, phenylenediamine derivatives, phosphonic acid esters, phosphorous acid esters, phenol compounds, hindered phenol compounds, linear amine compounds, cyclic amine compounds, hindered amine compounds and the like. It is understood that the present invention is not limited to these compounds.

Leveling agents such as silicone oil, fluorine type oils and the like may be included in the photosensitive layer 3, thereby improving the leveling properties of the formed film or providing further lubrication.

Furthermore, a surface protective layer 6 may further be formed on the surface of the photosensitive layer 3 for the purpose of further improving environmental resistance and mechanical strength. It is desirable that this surface protective layer 6 comprise a material that has superior durability against mechanical stress and environmental resistance, and further permits transmission of light at frequencies where the charge-generating layer is sensitive with as little loss as possible.

The surface protective layer 6 preferably comprises a layer having a resin binder, or an inorganic thin film of amorphous carbon and the like. Furthermore, improved conductivity, reduced coefficient of friction, improved lubricity and other properties may be obtained when the resin binder of the surface protective layer 6 comprises metal oxides such as silicon oxide (silica), titanium oxide, zinc oxide, calcium oxide, aluminum oxide (alumina), zirconium oxide and the like, metal sulfides such as barium sulfide, calcium sulfide and the like, metal nitrides such as silicon nitride, aluminum nitride and the like, fine particles of metal oxides, fluororesins such as tetrafluoroethylene resins and the like, particles of fluorine type comb graft polymer resins and the like.

Charge transporting properties are incorporated in the abovementioned photosensitive layer with a charge transporting material or alternatively, an electron acceptor substance may be included in the surface protective layer 6. A leveling agent such as silicone oil, a fluorinated oil or the like may be included to improve the leveling properties of the formed film or to provide lubricating properties.

Furthermore, although the film thickness of the surface protective layer 6 itself also depends on the composition of the layer, this thickness can be arbitrarily set in a range that produces no deleterious effects such as increased residual potential when there is continuous repeated use of the device.

The abovementioned coating liquid of the manufacturing method of the present invention can be used with various coating methods such as immersion coating, spray coating and the like, so that the type of coating method is substantially unrestricted.

The following more detailed examples illustrate various embodiments of the present invention.

### EXAMPLES OF SYNTHESIS

300 parts by weight of 1,4-dioxane (manufactured by Wako Pure Chemical Industries, Ltd.) and 60 parts by weight of a raw material vinyl chloride resin (MR 110 manufactured by Zeon Corporation) were charged in a four-necked flask, and the resin was heated and dissolved at 50° C. 27 parts by weight of acetic anhydride (manufactured by Wako Pure Chemical Industries, Ltd.) and 160 parts by weight of acetic acid (manufactured by Wako Pure Chemical Industries, Ltd.) were added to this solution drop-wise over a period of 15 minutes, and the solution was heated and agitated for a further 16 hours at 100° C.

Following completion of the reaction, the reactants were re-precipitated using 4 volumes of methanol and after filtering and air-drying a crude product was obtained.

The crude product thus obtained was dissolved in 1300 parts by weight of methylene chloride (manufactured by Wako Pure Chemical Industries, Ltd.) to form a solution, and suction filtered by adding 50 parts by weight of a synthetic adsorbing material (Kyowado 500, manufactured by Kyowa Chemical Industry Co., Ltd.) to this solution. The filtrate thus obtained was re-precipitated using a five-fold amount of n-hexane; then, following filtration and air drying, the product was dried under reduced pressure for 12 hours at room temperature, thus producing the desired vinyl chloride resin (compound A).

Esterification appears to occur as shown by the following formulae in the abovementioned reaction:
Esterification of Hydroxy Group Sites 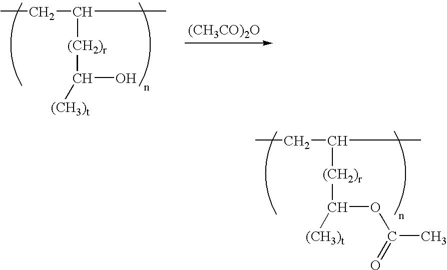
Esterification of Epoxy Group Sites 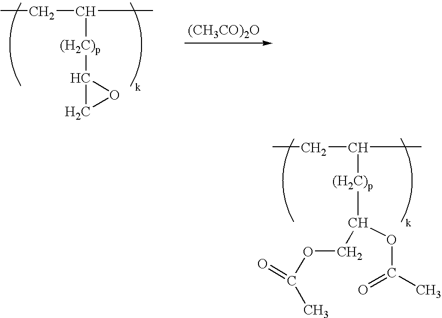
Measurement of Epoxy Equivalents

Compound A (see above) was precisely weighed within 0.1 mg units, and 30 ml of methyl ethyl ketone was added and dissolved to form a sample solution. 10 ml of glacial acetic acid, 1.0 g of cetyltrimethylammonium bromide (CTAB) and 10 to 15 drops of a crystal violet (CV) solution were added to the sample solution; the solution was immediately titrated using a 0.1 N perchloric acid standard solution (while agitation was continued) until a blue-green color was exhibited. The endpoint was taken as the point where a blue-green color continued for 1 minute.

A blank test was similarly performed, and the epoxy equivalents were calculated using the following equation:
(Epoxy equivalents) (g/equiv.)=1000 W/(Vs−Vb)×N
(In this equation, W is the number of grams of the sample, Vs is the number of milliliters of 0.1 N perchloric acid used, Vb is the number of milliliters of 0.1 N perchloric acid used in the blank test, and N indicates the normal concentration of the perchloric acid.)
Preparation of 0.1 N Perchloric Acid Standard Solution

Approximately 14.5 g of concentrated perchloric acid (specific gravity: 1.70, 70 wt %) was taken, approximately 500 ml of glacial acetic acid and 25 g of acetic anhydride were added and thoroughly mixed; then, this mixture was cooled to 20° C., and the total amount was adjusted to 1000 ml by adding glacial acetic acid.

Crystal Violet (CV) Solution

0.100 g of CV was dissolved in 100 ml of glacial acetic acid.

The results obtained were as follows:

Epoxy equivalents of vinyl chloride resin binder (MR 110): 1422 g/equiv.

Epoxy equivalents of compound A, as above (with a mean degree of polymerization of 300): 10,600 g/equiv.

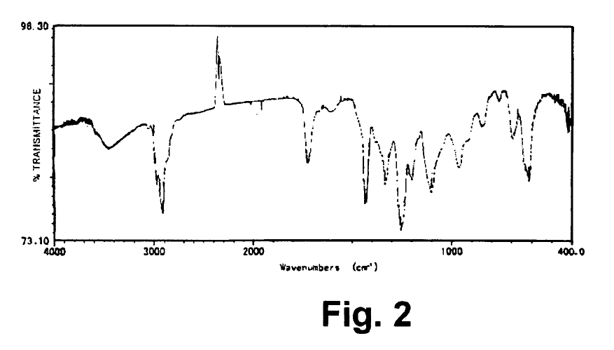

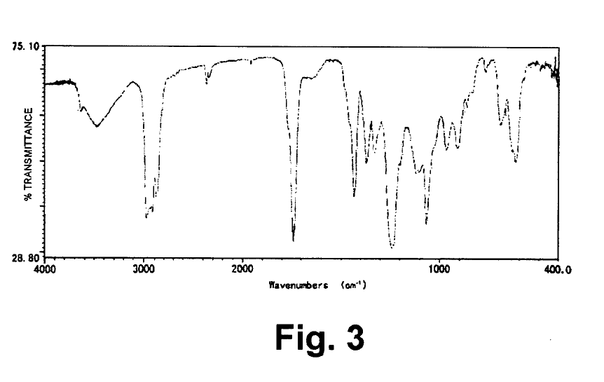

The infrared absorption spectrum of the vinyl chloride resin binder (MR 110) is shown in FIG. 2 and of compound A (see above) is shown in FIG. 3.

### EXAMPLE 1

A coating liquid prepared by dissolving and dispersing 5 parts by weight of alcohol-soluble nylon (Amilan CM 8000 manufactured by Toray Industries, Inc.) and 5 parts by weight of fine particles of aminosilane-treated titanium oxide in 90 parts by weight of methanol was immersion coated as an undercoat layer to the outer circumference of an aluminum cylinder used as a conductive substrate, and this coating was dried for 30 minutes at a temperature of 100° C., thus forming an undercoat layer with a film thickness of 2 μm.

A coating liquid prepared by dispersing 1.5 parts by weight of the Y type titanylphthalocyanine described in Japanese Patent Application Laid-Open No. 64-17066 (used as a charge generating material) and 1.5 parts by weight of the abovementioned compound A (used as a resin binder) in 60 parts by weight of a mixture of equal amounts of dichloromethane and dichloroethane for 1 hour by means of a mixer was immersion coated on top of this underlayer, and this coating was dried for 30 minutes at a temperature of 80° C., thus forming a charge generating layer with a film thickness of 0.3 μm.

A coating liquid prepared by dissolving 100 parts by weight of the compound indicated by the abovementioned structural formula (I-1) (used as a charge transporting material) and 100 parts by weight of a polycarbonate resin used as a resin binder (Panlite TS-2050 manufactured by Teijin Chemicals, Ltd.) in 900 parts by weight of dichloromethane and then adding 0.1 parts by weight of a silicone oil (KP-340 manufactured by Shin-Etsu Polymer Co., Ltd.) was immersion coated on top of the abovementioned charge generating layer, and this coating was dried for 60 minutes at a temperature of 90° C., thus forming a charge transporting layer with a film thickness of 25 μm, and completing the manufacture of an electrophotographic photosensitive device.

### EXAMPLE 2

An electrophotographic photosensitive device was manufactured by the same method as in Example 1, except that the resin binder used in the charge generating layer of Example 1 was replaced with a combination of 1 part by weight of the abovementioned compound A and 0.5 parts by weight of a polyvinylbutyral resin (S-Lec BX-1 manufactured by Sekisui Chemical Co., Ltd.).

### EXAMPLE 3

An electrophotographic photosensitive device was manufactured by the same method as in Example 1, except that the resin binder used in the charge generating layer of Example 1 was replaced with a combination of 1 part by weight of the abovementioned compound A and 0.5 parts by weight of a polyvinylacetal resin (S-Lec KS-1 manufactured by Sekisui Chemical Co., Ltd.).

### EXAMPLE 4

An electrophotographic photosensitive device was manufactured by the same method as in Example 1, except that the charge generating material used in Example 1 was replaced with the α type titanylphthalocyanine described in Japanese Patent Application Laid-Open No. 61-217050.

### EXAMPLE 5

An electrophotographic photosensitive device was manufactured by the same method as in Example 1, except that the charge generating material used in Example 1 was replaced with an X type non-metallic phthalocyanine (Fastgen Blue 8120B manufactured by Dainippon Ink and Chemicals, Inc.).

### COMPARATIVE EXAMPLE 1

An electrophotographic photosensitive device was manufactured by the same method as in Example 1, and a vinyl chloride resin, MR 110 (manufactured by Zeon Corporation) was used instead of compound A used in Example 1, above.

### COMPARATIVE EXAMPLE 2

An electrophotographic photosensitive device was manufactured by the same method as in Example 1, and a polyvinylbutyral resin (S-Lec BX-1 manufactured by Sekisui Chemical Co., Ltd.) was used instead of compound A used in Example 1, above.

### COMPARATIVE EXAMPLE 3

An electrophotographic photosensitive device was manufactured by the same method as in Example 1, and a polyvinylacetal resin (S-Lec KS-1 manufactured by Sekisui Chemical Co., Ltd.) was used instead of compound A used in Example 1, above.

### COMPARATIVE EXAMPLE 4

An electrophotographic photosensitive device was manufactured by the same method as in Example 1, and a vinyl chloride resin MR 110 (manufactured by Zeon Corporation) was used instead of compound A used in Example 1, above, and an α type titanylphthalocyanine was used as the charge generating material.

### COMPARATIVE EXAMPLE 5

An electrophotographic photosensitive device was manufactured by the same method as in Example 1, and a vinyl chloride resin MR 110 (manufactured by Zeon Corporation) was used instead of compound A used in Example 1, above, and an X type non-metallic phthalocyanine was used as the charge generating material.

The electrophotographic characteristics of the photosensitive devices manufactured in the abovementioned Examples 1 through 5 and Comparative Examples 1 through 5 were evaluated by the following method. Specifically, after the surface of the photosensitive device was charged to −650 V using a corona discharge in the dark, the surface potential V₀ immediately following charging was measured. Then, the surface potential V₅ following the discharge of another corona discharge for 5 seconds in a dark place was measured, and the potential retention rate Vₖ₅ (%) at 5 seconds following discharge was determined by the following equation (1):
Vₖ₅=(V₅/V₀)×100 (1)

Next, the photosensitive device was irradiated for 5 seconds using a halogen lamp light source (from the time at which the surface potential reached −600 V) with the exposing light adjusted to 780 nm using a filter. The amount of exposure required for the surface potential to undergo light attenuation to −300 V was determined as E_{1/2} (μJ-cm⁻²), and the amount of exposure required for the surface potential to undergo light attenuation to −50 V was determined as E₅₀ (μJ-cm⁻²).

With reference to the abovementioned experiments, the electrical characteristics of the photosensitive devices manufactured in Examples 1 through 5 and Comparative Examples 1 through 5 are shown in Table 1 (see below).

TABLE 1

| | Charge | | | E_{1/2} | E₅₀ |
|---|---|---|---|---|---|
| | generating | | Vₖ₅ | (μJ · | (μJ · |
| | material* | Resin binder | (%) | cm⁻²) | cm⁻²) |
| Example 1 | Y-TiOPc | Compound A | 94.6 | 0.34 | 1.09 |
| Example 2 | Y-TiOPc | Compound A + | 94.7 | 0.33 | 1.10 |
| | | BX-1 | | | |
| Example 3 | Y-TiOPc | Compound A + | 94.6 | 0.34 | 1.02 |
| | | KS-1 | | | |
| Example 4 | α-TiOPc | Compound A | 96.3 | 0.55 | 1.54 |
| Example 5 | X-H₂Pc | Compound A | 95.0 | 0.89 | 2.35 |
| Comparative | Y-TiOPc | MR110 | 94.5 | 0.35 | 1.00 |
| Example 1 | | | | | |
| Comparative | Y-TiOPc | BX-1 | 94.8 | 0.37 | 1.25 |
| Example 2 | | | | | |
| Comparative | Y-TiOPc | KS-1 | 94.8 | 0.41 | 1.10 |
| Example 3 | | | | | |
| Comparative | α-TiOPc | MR110 | 96.3 | 0.57 | 1.64 |
| Example 4 | | | | | |
| Comparative | X-H₂Pc | MR110 | 95.0 | 0.91 | 2.40 |
| Example 5 | | | | | |

*Y-TiOPc: Y type titanylphthalocyanine
a-TiOPc: a type titanylphthalocyanine
X-H₂Pc: x type non-metallic phthalocyanine

With reference to Table 1, above, even if compound A of the present invention is used as the resin binder of the charge generating layer, there is no great effect on the initial electrical characteristics (Vₖ₅, E_{1/2}, E₅₀) compared to a case where MR 110 is used (see Table 1 above for a comparison of Example 1 and Comparative Example 1).

Furthermore, almost no fluctuation in the electrical characteristics (Vₖ₅, E_{1/2}, E₅₀) was seen compared to MR 110, even when the charge generating material was changed (see Table 1 above for a comparison of Examples 4 and 5 and Comparative Examples 4 and 5).

Next, the photosensitive devices manufactured in Examples 1 through 3 and Comparative Examples 1 through 3 were mounted in a digital copying machine with a magnetic two-component developing system modified to allow measurement of the surface potential of the photosensitive device, and the stability of the potential and the image memory before and after repeated printing of 100,000 copies and the results of this procedure were evaluated. The results obtained are shown in Table 2 (see below). (see below).

TABLE 2

| | | | Initial | Initial | Bright part | Amount | Evaluation of |
|---|---|---|---|---|---|---|---|
| | Charge | | bright part | image | potential | of variation | image memory |
| | generating | Resin | potential | memory | after 100,000 | in bright part | after repeated |
| | Material* | Binder | (−V) | evaluation | copies (−V) | potential (−V) | printing |
| Example 1 | Y-TiOPc | Compound | 115 | ◯ | 120 | 5 | ◯ |
| | | A | | | | | |
| Example 2 | Y-TiOPc | Compound | 121 | ◯ | 123 | 2 | ◯ |
| | | A + BX-1 | | | | | |
| Example 3 | Y-TiOPc | Commpound | 117 | ◯ | 121 | 4 | ◯ |
| | | A + KS-1 | | | | | |
| Comparative | Y-TiOPc | MR110 | 117 | ◯ | 123 | 6 | ◯ |
| Example 1 | | | | | | | |
| Comparative | Y-TiOPc | BX-1 | 130 | ◯ | 134 | 4 | X |
| Example 2 | | | | | | | (Positive) |
| Comparative | Y-TiOPc | KS-1 | 141 | ◯ | 153 | 12 | X |
| Example 3 | | | | | | | (Positive) |

* Y-TiOPc: Y type titanylphthalocyanine

In the image evaluations of Tables 1 and 2, above, a checkered flag pattern was read in the front pattern was read in the half of the scanner scan. Similarly, in the printing evaluation of the image samples subjected to a halftone treatment in the rear half of the scanner scan, a memory image reflecting a checkered flag pattern in the halftone parts was read. Samples in which no memory was observed were marked with a O symbol in Table 2, above, and samples in which memory was observed were marked with an x symbol in Table 2, above. Samples where the optical density appeared in the same manner as in the original image were evaluated as positive. Similarly, samples in which an image appeared with the optical density reversed (inverted) from that of the original image were evaluated as negative.

Initial actual electrical characteristics showed no great differences. However, in the potential and image evaluation following repeated printing of 100,000 copies, a great difference was observed between cases in which compound A of the present invention was used as the resin binder in the charge generating layer compared to cases in which this compound was not used, and it was clear that a rise in the residual potential and image memory deterioration could be sufficiently prevented.

Next, the potential characteristics of the photosensitive bodies in respective use environments ranging from low temperature and low humidity to high temperature and high humidity (using the abovementioned digital copying machine) were investigated, and image evaluation was performed concurrently. The results are shown in Table 3 (see below).

TABLE 3

| | | | | | | Variation in | | |
|---|---|---|---|---|---|---|---|---|
| | | | | | | residual potential | | |
| | | | | | | between low | | |
| | | | Low | Ordinary | High | temperature low | Memory | Memory |
| | Charge | | temperature | temperature | temperature | humidity and high | evaluation at | evaluation at |
| | generating | Resin | low humidity | ordinary humidity | high humidity | temperature high | high temperature | low temperature |
| | material* | binder | (−V) *1 | (−V) *2 | humidity (−V) *3 | humidity (−V) | high humidity | low humidity |
| Example 1 | Y-TiOPc | Compound | 135 | 115 | 60 | 75 | ◯ | ◯ |
| | | A | | | | | | |
| Example 2 | Y-TiOPc | Compound | 146 | 121 | 66 | 80 | ◯ | ◯ |
| | | A + BX-1 | | | | | | |
| Example 3 | Y-TiOPc | Compound | 143 | 117 | 72 | 71 | ◯ | ◯ |
| | | A + KS-1 | | | | | | |
| Comparative | Y-TiOPc | MR110 | 166 | 117 | 55 | 111 | Δ | X |
| Example 1 | | | | | | | (positive) | (negative) |
| Comparative | Y-TiOPc | BX-1 | 236 | 130 | 62 | 174 | Δ | X |
| Example 2 | | | | | | | (positive) | (Negative) |
| Comparative | Y-TiOPc | KS-1 | 263 | 141 | 66 | 197 | Δ | X |
| Example 3 | | | | | | | (positive) | (negative) |

* Y-TiOPc: Y type titanylphthalocyanine
*1: temperature 5° C., humidity 10%
*2: temperature 25° C., humidity 50%
*3: temperature 35° C., humidity 85%

Meaning of Evaluation: (good) O ← → Δ ← → x (poor). With reference to memory conditions, the evaluation results are as noted in Table 3, above.

It is clear from the results shown in Table 3, above that the use of compound A of the present invention as the resin binder in the charge generating layer results in a reduced environmental dependence for the potential and images, and in particular in greatly improved memory at low temperatures.

Furthermore, the photosensitive devices manufactured in Examples 4 and 5 and Comparative Examples 4 and 5 were mounted in a facsimile machine with a non-magnetic single component developing system that was modified so as to allow measurement of the surface potential of the photosensitive device and the stability of the potential and the image memory that were seen when the use environment of this modified facsimile machine was varied and was evaluated. The results obtained are shown in The results obtained are shown in Table 4 (see below).

TABLE 4

| | | | | | | Var. in resid. | | |
|---|---|---|---|---|---|---|---|---|
| | | | | | | pot. betw. | | |
| | | | | | | low temp. low | Memory | Memory |
| | Charge | | Low temp. | Ord. temp | High temp. | humidity & high | eval. at high | eval. at low |
| | generating | Resin | low humidity | ord. humidity | high humidity | temp. high | temp. high | temp. low |
| | material* | binder | (−V) *1 | (−V) *2 | (−V) *3 | humidity (−V) | humidity | humidity |
| Ex. 4 | α-TiOPc | Compound A | 110 | 90 | 55 | 55 | ◯ | ◯ |
| Ex. 5 | X-H₂Pc | Compound A | 175 | 141 | 118 | 57 | ◯ | ◯ |
| Comp. | α-TiOPc | MR110 | 155 | 110 | 72 | 83 | Δ (pos.) | X (neg.) |
| Ex. 4 | | | | | | | | |
| Comp. | X-H₂Pc | MR110 | 200 | 160 | 105 | 95 | Δ (pos.) | X (neg.) |
| Ex. 5 | | | | | | | | |

α-TiOPc: α type titanylphthalocyanine
X-H₂Pc: X type nonmetallic phthalocyanine
*1: temperature 5° C., humidity 10%
*2: temperature 25° C., humidity 50%
*3: temperature 35° C., humidity 85%

With reference to the memory classification (positive, negative), the evaluation results are as noted in Table 4, above.

As is shown in the abovementioned Table 4, the use of compound A of the present invention as the resin binder of the charge generating layer resulted in a photosensitive device in which environmental characteristics fluctuation was suppressed even in cases where a titanylphthalocyanine with a different crystal form or an X type non-metallic phthalocyanine was used.

The electrophotographic photosensitive device of the present invention makes it possible to obtain the abovementioned effects when this electrophotographic photosensitive device is used in various types of machine processes. Specifically, the electrophotographic photosensitive device of the present invention makes it possible to obtain a sufficient effect in charging processes of contact charging systems using rollers or brushes, or of non-contact charging systems using Colotrons, Scorotrons and the like, as well as in developing processes of contact developing and non-contact developing systems using developing systems such as non-magnetic single component, magnetic single component or two component systems.

While the disclosure has been particularly shown and described with reference to preferred embodiments thereof, it will be understood by those skilled in the art that the foregoing and other changes in form and details may be made therein without departing from the spirit and scope of the disclosure.

1. An electrophotographic photosensitive device comprising a photosensitive layer on a conductive substrate, including a vinyl chloride resin, said vinyl chloride resin comprising an acid esterified vinyl chloride having polymer hydroxy groups, epoxy groups and strong acid radicals as substituent groups, so that a portion of said epoxy groups and a portion of said hydroxy groups are esterified.

2. The electrophotographic photosensitive device according to claim 1, wherein said photosensitive layer is a function-separating laminated type electrophotographic photosensitive device having a charge generating layer and a charge transporting layer, and said esterified vinyl chloride resin is used as a binder resin in said charge generating layer.

3. The electrophotographic photosensitive device according to claim 2, wherein the charge generating material of said charge generating layer is a non-metallic phthalocyanine.

4. The electrophotographic photosensitive device according to claim 2, wherein the charge generating material of said charge generating layer is titanylphthalocyanine.

5. The electrophotographic photosensitive device according to claim 4, wherein said titanylphthalocyanine is characterized by having a maximum amplitude at 27.2° in the Bragg angle 2θ X-ray crystal diffraction of said titanylphthalocyanine.

6. The electrophotographic photosensitive device according to claim 1, wherein the mean degree of polymerization of said vinyl chloride resin is about 200 to about 600.

7. The electrophotographic photosensitive device according to any one of claims 6, wherein said photosensitive layer is a function-separating laminated type electrophotographic photosensitive device having a charge generating layer and a charge transporting layer, and said esterified vinyl chloride resin is used as a binder resin in said charge generating layer.

8. The electrophotographic photosensitive device according to claim 7, wherein the charge generating material of said charge generating layer is a non-metallic phthalocyanine.

9. The electrophotographic photosensitive device according to claim 7, wherein the charge generating material of said charge generating layer is titanylphthalocyanine.

10. The electrophotographic photosensitive device according to claim 9, wherein said titanylphthalocyanine is characterized by having a maximum amplitude at 27.2° in the Bragg angle 2θX-ray crystal diffraction of said titanylphthalocyanine.

11. The electrophotographic photosensitive device according to claim 1, wherein the epoxy equivalents of said vinyl chloride resin are at least approximately 2,000 g/equiv. and no greater than approximately 20,000 g/equiv.

12. The electrophotographic photosensitive device according to any one of claims 11, wherein said photosensitive layer is a function-separating laminated type electrophotographic photosensitive device having a charge generating layer and a charge transporting layer, and said esterified vinyl chloride resin is used as a binder resin in said charge generating layer.

13. The electrophotographic photosensitive device according to claim 12, wherein the charge generating material of said charge generating layer is a non-metallic phthalocyanine.

14. The electrophotographic photosensitive device according to claim 12, wherein the charge generating material of said charge generating layer is titanylphthalocyanine.

15. The electrophotographic photosensitive device according to claim 14, wherein said titanylphthalocyanine is characterized by having a maximum amplitude at 27.2° in the Bragg angle 2θ X-ray crystal diffraction of said titanylphthalocyanine.

16. The electrophotographic photosensitive device according to claim 11, wherein the mean degree of polymerization of said vinyl chloride resin is about 200 to about 600.

17. The electrophotographic photosensitive device according to any one of claims 16, wherein said photosensitive layer is a function-separating laminated type electrophotographic photosensitive device having a charge generating layer and a charge transporting layer, and said esterified vinyl chloride resin is used as a binder resin in said charge generating layer.

18. The electrophotographic photosensitive device according to claim 17, wherein the charge generating material of said charge generating layer is a non-metallic phthalocyanine.

19. The electrophotographic photosensitive device according to claim 17, wherein the charge generating material of said charge generating layer is titanylphthalocyanine.

20. The electrophotographic photosensitive device according to claim 19, wherein said titanylphthalocyanine is characterized by having a maximum amplitude at 27.2° in the Bragg angle 2θ X-ray crystal diffraction of said titanylphthalocyanine.

21. A method for manufacturing an electrophotographic photosensitive device comprising the step of: coating the surface of a conductive substrate with a coating liquid thereby providing a photosensitive layer including an electrophotographic photosensitive material, said coating liquid comprising a vinyl chloride resin, said vinyl chloride resin being an acid esterified vinyl chloride polymer having polymer hydroxy groups, epoxy groups and strong acid radicals as substituent groups, so that a portion of said epoxy groups and a portion of said hydroxy groups are esterified.
